(19) United States
(12) Patent Application Publication
(10) Pub. No.: US 2026/0327020 A1
(43) Pub. Date: Oct. 22, 2026

(54) PRODUCT SORTING AND PACKAGING SYSTEM AND METHOD

(71) Applicant: SANOVO TECHNOLOGY NETHERLANDS B.V., Aalten (NL)

(72) Inventor: Jan HORDIJK, Aalten (NL)

(21) Appl. No.: 19/107,622

(22) PCT Filed: Sep. 6, 2023
(86) PCT No.: PCT/EP2023/074455

§ 371 Date: Feb. 28, 2025

(30) Foreign Application Priority Data
Sep. 7, 2022 (NL) 2032984

(51) Int. Cl. B65G 47/68; A01K 43/08; B65B 23/06

(52) U.S. Cl. CPC B65G 47/684; A01K 43/08; B65B 23/06; B65G 2201/0208

(57) ABSTRACT

Products of a batch are sorted into respective product classes and are distributed by a circulating conveyor into respective buffers (5) of respective packing lanes (4). Packages (8) move along the buffer. A filled row of the buffer (5) is transferred to a row in one of the packages (8). The end of the batch of products is detected or the end of an order of products is detected. A normal filling mode is switched to an end filling mode based on said end of batch or end of order detection. In the end filling mode the respective packing lanes (4) are shut down one by one until there is one packing lane (4) left in operation. A packing lane (4) is shut down at the moment that the buffer (5) thereof is fully filled and fills up a (final) row of a package or an entire package (8).

### FIELD OF THE INVENTION

The invention relates to a product sorting and packaging system and a product sorting and packaging method, wherein products in a batch are graded into product classes and sorted and distributed to be packaged as the specific product class.

### BACKGROUND OF THE INVENTION

A product sorting and packaging system comprises:
a grading device for grading the products of a batch into respective product classes,
at least one circulating conveyor track having product holders for receiving the sorted products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package.

The sorting and packaging system has a normal filling mode, in which the products are distributed by the circulating conveyor track into the respective buffers using a distribution algorithm, based on the product classes and an optimal use of the capacity of packing lanes assigned to a certain product class.

Such a sorting and packing system can typically be used for eggs.

The products are thus not fed by the circulating conveyor track in the first available packing lane but are distributed in an optimal way to use the available packing lane capacity. In the normal filling mode the buffer of a packing lane only feeds products to the packages when the buffer is completely filled. However at some point the batch of product ends. If product batches cannot be mixed, the normal filling mode results in buffers that are not completely filled. The non-entirely filled buffers are then emptied in the packages, which results in non-entirely filled packages, e.g. rows with empty spots. It is also possible that the number of filled rows of the buffer does not correspond to the number of rows of an integer number of packages, which results in packages with empty rows.

Non entirely filled packages cannot be used and mean a loss. Therefore the operators of the system collect the non-entirely filled packages and manually redistribute the products such that the maximum number of totally filled packages is obtained and the loss is minimized.

This is not an efficient process. Moreover the manually filled packages have to be fed manually to a printing or labelling machine and the traceability of the products is lost.

It is an object of the invention to make the filling process more efficient in an automated way.

This object is achieved by a sorting and packaging system according to the invention.

### SUMMARY OF THE INVENTION

A sorting and packaging system comprising:
a grading device for grading the products of a batch into respective product classes,
at least one circulating conveyor track having product holders for receiving the graded products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
a computer for controlling the sorting and packaging system and configured with a distribution algorithm. The sorting and packaging system has a normal filling mode, in which the sorting and packaging system is controlled by the computer such that the products are distributed by the circulating conveyor track into the respective buffers using the distribution algorithm, based on the product classes and an optimal use of the capacity of packing lanes assigned to a certain product class. The sorting and packaging system has a warning system adapted to detect an end of a batch of products or an end of an order of products and adapted to generate a warning signal when the end of the batch of products is detected or when the end of an order is detected. The sorting and packaging system has an end filling mode. A switch from the normal filling mode to the end filling mode is triggered by the warning signal of the warning system. In the end filling mode the sorting and packaging system is controlled by the computer such that the respective packing lanes are shut down one by one until there is one packing lane left in operation, wherein each one of the respective packing lanes is shut down at the moment that the buffer device thereof is fully filled to fill up a row of a package or an entire package.

The switch of the filling mode to the end filling mode of the sorting and packaging system at the moment that the end of the batch is arriving or the end of an order is arriving, prevents automatically many partially empty packages. It results in that eventually only one packing lane may end up with a non-entirely filled package. This minimizes the loss and prevents manual collection of products and partially empty packages.

In some applications the products of consecutive incoming batches may be mixed. However, the number of packages filled with a mix of two batches is preferably kept to a minimum. The switch from a the normal filling mode to the end filling mode, as described in the above, can be used in a similar way to minimize the number of packages with a mix of products coming from consecutive batches: Each one of the respective packing lanes is shut down at the moment that the buffer device thereof is fully filled to fill up a row of a package or an entire package. The products from the next batch are thus only mixed with products of the previous batch in the packing lane that is not shut down. After the last package is filled with a mix of products coming from the consecutive batches, the system can switch to normal filling mode again. Thereby all packing lanes are open again and the packages can be filled exclusively with products from the second batch. Thus, the transition between two incoming batches of products results only in one outgoing package containing a mix of products coming from the two incoming batches.

In an embodiment the warning system is adapted to generate the warning signal when the end of the batch or the order is detected at a predetermined location in the supply line, preferably in the grading device. The detection used to generate the warning signal is located sufficiently far upstream of the packing lines to enable the system to switch the filling mode in time, such that all packages can be filled except one.

The warning system may comprise a computer and a detector, wherein the computer is configured to run an algorithm, which generates a warning signal based on the input signal coming from the detector. Preferably a detector used for the grading process is also used for detecting the end of a batch and generating an input signal for the computer. This may for example be a weight sensor that weighs the eggs and also detects that there is no egg to be weighed anymore, which is an indication that the end of the batch has passed. Also other sensors may be used such as for example optical sensors to detect the presence of an egg on a location.

In another embodiment the warning system is adapted to generate the warning signal when is detected that the end of the batch is a predetermined number of products away, e.g. 100, from the first packing lane assigned to the product class concerned. In this embodiment the warning system may take account of the number of packing lanes and the percentage of products in a product class in the batch. A controller, incorporated in a computer, and controlling the sorting and packaging system, knows where individual products are in the sorting and packaging system, and thus knows how the end of a batch travels through the sorting and packaging system. Once the end of the batch is a predetermined number of positions away from the first packing lane, e.g. 100 positions, the warning system, which is incorporated in the computer, generates the warning signal.

In an embodiment the warning system may be incorporated in the computer used for controlling the sorting and packaging system.

Another aspect of the invention relates to a product sorting and packaging system comprising:
a grading device for grading the products of a batch into respective product classes,
at least one circulating conveyor track having product holders for receiving the sorted products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
a computer for controlling the sorting and packaging system and configured with a distribution algorithm.

According to this aspect the sorting and packaging system has a filling mode, in which the products are distributed by the circulating conveyor track into the respective buffers using the distribution algorithm which feeds the products of a certain product class fed to packing lanes assigned to said product class such that the buffer rows of different packing lanes are filled successively, such that a buffer row can be entirely filled before products are fed to a next packing lane.

The product sorting and packaging system according to this aspect is mainly suitable for packages having two rows of products, e.g. for egg cartons having 2×6 pockets. In such a two-row package the chance that the final package in a packing lane is non-entirely filled is 50%. This is already an improvement with regard to the prior art systems, where the chance that each packing line ends up with a non-entirely filled package is considerably higher and may be 100%.

In a further embodiment the distribution algorithm feeds the products to the packing lanes such that a package can be entirely filled before products are fed to a next packing lane. It is a simple solution which does not require a warning system and which eventually also results in at most one package which is not entirely filled. This embodiment may also be used in an application in which products of two consecutive batches may be mixed, but the number of packages containing a mix is preferably minimized. With this embodiment at most one package ends up with a mix of products coming from two batches.

In an embodiment of the product sorting and packaging system, the computer is configured to know where individual products are in the sorting and packaging system.

The invention also relates to a product sorting and packaging method wherein:
products of a batch are sorted into respective product classes,
the sorted products are moved by a circulating conveyor track,
in a normal filling mode, the products are distributed by the circulating conveyor track into respective buffers of a packing lane using a distribution algorithm, based on the product classes and an optimal use of the capacity of packing lanes assigned to a certain product class,
packages are conveyed along the buffer, wherein a filled row of the buffer is transferred to a row in one of the packages,
wherein the end of the batch of products is detected or the end of an order of products is detected, and the normal filling mode is switched to an end filling mode based on said end of batch or end of order detection, in which end filling mode the respective packing lanes assigned to a certain product class are shut down one by one until there is one packing lane assigned to said product class left in operation, wherein the packing lane is shut down at the moment that the buffer device thereof is fully filled and fills up a (final) row of a package or an entire package.

The switch of the filling mode to the end filling mode at the moment that end of the batch is arriving or the end of an order is arriving, prevents automatically many partially empty packages. It results in that eventually only one packing lane may end up with a non entirely filled package. This minimizes the loss and prevents that manual collection of products and partially empty packages is necessary.

If a mix of products coming from two consecutively handled batches is allowed, this method according to the invention may be used to end up with at most one package containing a mix of products coming from the two batches. Each one of the respective packing lanes is shut down at the moment that the buffer device thereof is fully filled to fill up a row of a package or an entire package. The products from the next batch are thus initially only fed to the last packing lane that is not shut down. Thus only in that packing lane a mix of products from two batches can occur, and it can only occur in one package. After the last package is filled with a mix of products coming from the consecutive batches, the system can switch to normal filling mode again. Thereby all packing lanes are open again and the packages can be filled exclusively with products from the second batch. Thus, the transition between two incoming batches of products results only in one outgoing package containing a mix of products coming from the two incoming batches.

In this method said end of batch or end of order is detected at a predetermined location in the supply line, preferably at a location where the products are sorted.

Possibly the filling mode is switched from the normal filling mode to the end filling mode when is detected that the end of the batch is a predetermined number of products away, e.g. 100 or 200, from the first packing lane assigned to the product class concerned. When switching the filling mode account may be taken of the number of packing lanes and the percentage of products in a product class in the batch.

The invention also relates to a product sorting and packaging method comprising:
grading the products of a batch into respective product classes,
the graded products are moved by a circulating conveyor track,
the products are distributed by the circulating conveyor track into respective buffers of a packing lane based on the product classes and an optimal use of the capacity of packing lanes assigned to a certain product class,
wherein the products are distributed by the circulating conveyor track into the respective buffers such that the buffer rows of different packing lanes are filled successively, such that a buffer row can be entirely filled before products of the same product class are fed to a next packing lane.

This method is mainly suitable for filling packages having two rows of products, e.g. for egg cartons having 2×6 pockets. In such a two-row package the chance that the final package in a packing lane is entirely filled is 50%. This is already an improvement with regard to the prior art methods, where the chance that each packing line ends up with a non-entirely filled package is considerably higher and may be 100%.

In this method the products may be fed to the packing lanes such that a package can be entirely filled before products are fed to a next packing lane. It is a simple solution which does not require looking forward and a warning and which eventually also results in only one package which is not entirely filled.

### Another Aspect of the Invention Relates to a Product Sorting and Packaging System

comprising:
a grading device for grading the products of a batch into respective product classes,
at least one circulating conveyor track having product holders for receiving the graded products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
wherein the sorting and packaging system has a normal filling mode, in which the products are distributed by the circulating conveyor track into the respective buffers using a distribution algorithm, based on the product classes and an optimal use of the capacity of packing lanes assigned to a certain product class,
wherein the sorting and packaging system has a warning system adapted to detect an end of a batch of products or an end of an order of products and adapted to generate a warning signal when the end of the batch of products is detected or when the end of an order is detected,
wherein the sorting and packaging system has an end filling mode, wherein a switch from the normal filling mode to the end filling mode is triggered by the warning signal of the warning system,
wherein in the end filling mode the respective packing lanes are shut down one by one until there is one packing lane left in operation, wherein each one of the respective packing lanes is shut down at the moment that the buffer device thereof is fully filled to fill up a row of a package or an entire package, and
wherein the product sorting and packaging system further comprises a computer configured to carry out any of the methods as described in the above.

The above systems and methods are suitable for any type of products that have to be sorted and packed. In particular eggs or fruits can be sorted packed.

The invention will be further elucidated in the following description with reference to the drawings.

### BRIEF DESCRIPTION OF THE DRAWINGS

FIG. 1 shows schematically an egg sorting and packaging system;

FIGS. 2A and 2B illustrate schematically a method according to the prior art to handle eggs at an end of a batch of eggs with a system of FIG. 1;

FIGS. 3A and 3B illustrate schematically a method according to the invention to handle eggs at an end of a batch of eggs with a system of FIG. 1;

FIGS. 4A and 4B illustrate schematically another method according to the invention to handle eggs at an end of a batch with a system of FIG. 1 without a warning device;

FIG. 5A illustrates schematically packages which are filled with eggs of consecutive batches with a method according to the prior art; and

FIG. 5B illustrates schematically packages which are filled with eggs of consecutive batches with a method according to the invention.

### DETAILED DESCRIPTION

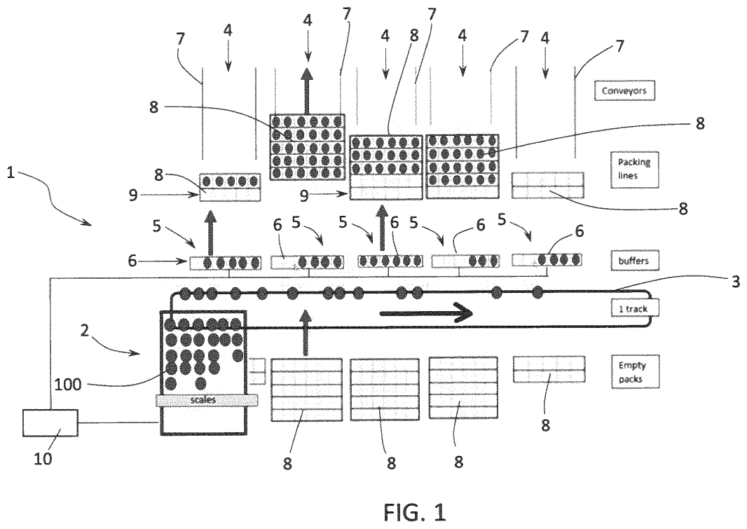

In FIG. 1 is shown an egg sorting and a packaging system 1. The system 1 comprises a grading device 2 for grading the eggs 100 of a batch into respective product classes. The grading device 2 in the shown example comprises scales to determine the weight of the individual eggs 100. The weight of the eggs 100 is for example used to determine the product class. It is known to grade eggs also on other parameters, for example size or colour.

The product class is registered by a control system. The control system may comprise a computer configured with control algorithms. The eggs 100 are transferred to a circulating conveyor track 3 having egg holders for receiving the graded eggs 100 from the sorting device 2. Such a circulating conveyor track 3 is in case of eggs, often referred to as an egg chain. The control system keeps track of the individual eggs 100 that are located on the circulating conveyor track 3. The graded eggs 100 are sorted by feeding the individual eggs 100 to a certain packing lane 4 of a plurality of packing lanes 4, where eggs 100 of that specific grade are packed.

The system 1 comprises a plurality of packing lanes 4 associated with the circulating conveyor track 3. In the example shown in FIG. 1 the system has five packing lanes, which represents the group of packing lanes associated with the particular product class. There may be more packing lanes-a system may have up to thirty two packing lanes-but these are used to pack another product class. For clarity reasons, only the five (by way of example) packing lanes packing the same product class are depicted.

Each packing lane 4 includes a buffer device 5 having a plurality of rows 6 of product holders for receiving individual eggs 100 from the egg holders of the circulating conveyor track 3.

Each packing lane 4 includes a package conveyor 7 to convey packages 8 along the buffer device 5. The packages may be dimpled packages having pockets to receive individual eggs, as is known from common egg trays or common egg cartons. In general, the packages 8 will pass underneath the buffer 5. The packing lane 4 is adapted to transfer a filled row 6 of the buffer device 5 to a row 9 of egg pockets in a package 8.

The sorting and packaging system 1 has a normal filling mode, in which the eggs 100 are distributed by the circulating conveyor track 3 into the respective buffers 5 using a distribution algorithm, based on the product classes and an optimal use of the capacity of packing lanes 4 assigned to a certain product class. The package may for example be an egg carton having two rows of five pockets to receive eggs. The package may for example also be an egg tray having five rows of six pockets. Different packing lanes 4 may handle different types of packages 8 as is illustrated in FIG. 1, where the first and fifth lane 4 handle 2×5 egg cartons and the second to fourth lanes 4 handle 5×6 egg trays. Also other packages having other arrays of pockets are possible. When a buffer row 6 is filled, the eggs 100 therefrom can be transferred to a package row 9. The package 8 is thus filled row by row. The eggs are not fed by the circulating conveyor track 3 in the first available packing lane 4, but are distributed, based on the distribution algorithm, in a way to use the available capacity of the packing lanes 4 optimally.

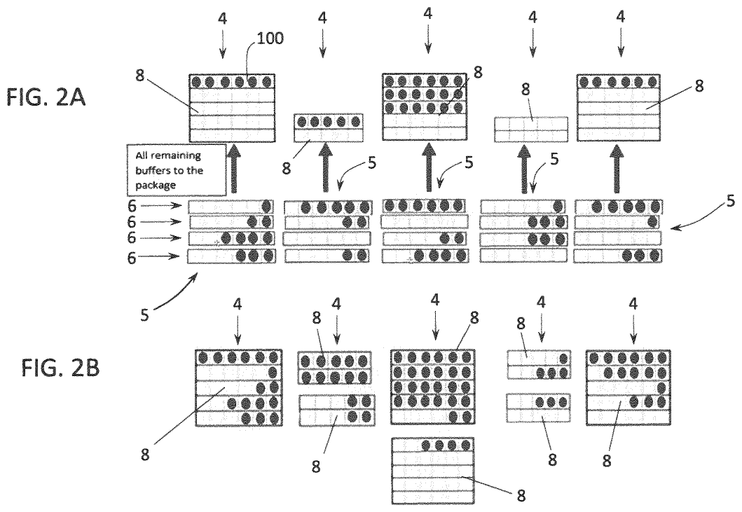

Due to this distribution strategy, the buffers 5 may have rows 6 which are not entirely filled at some point in time. This situation is shown in FIG. 2A. According to the state of the art, the non-entirely filled buffer rows 6 are emptied in the packages 8 when the end of the batch reaches the packing lanes 4, whereby probably each packing lane 4 associated with this specific grade of eggs has at least one incompletely filled package 8. This situation is shown in FIG. 2B. Non entirely filled packages cannot be used and mean a loss. Therefore the operators of the system collect the non-entirely filled packages 8 and manually redistribute the eggs such that the maximum number of totally filled packages 8 is obtained and the loss is minimized. This is however inefficient.

According to the invention the sorting and packaging system 1 has a warning system 10 adapted to detect an end of a batch of eggs or an end of an order of eggs. The warning system 10 is adapted to generate a warning signal when the end of the batch of eggs is detected or when the end of an order is detected. In a practical embodiment the warning system comprises an algorithm run on the same computer that runs the distribution algorithm. The warning system may furthermore comprise a sensor or other detector which can detect the end of a batch is connected to the computer and provides the algorithm with an input signal. In the example of FIG. 1 the scales used to determine the weight of the individual eggs may also be used to detect the end of the batch.

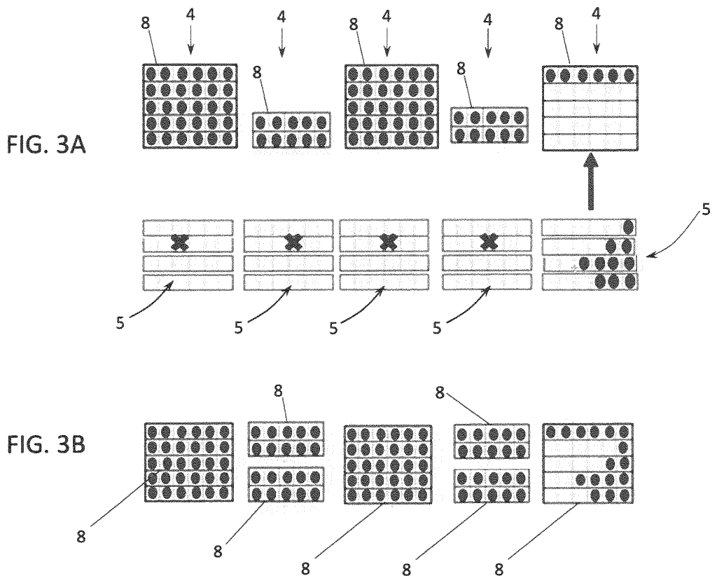

The sorting and packaging system 1 of the invention has an end filling mode. The sorting and packaging system 1 can switch from the normal filling mode to the end filling mode. The switch from the one mode to the other mode is triggered by the warning signal of the warning system 10. In the end filling mode the respective packing lanes 4 are shut down one by one until there is one packing lane 4 left in operation. This is shown in FIG. 3A. Each one of the respective packing lanes 4 is shut down at the moment that the buffer device 5 thereof is fully filled to fill up a row 9 of a package 8 or an entire package 8.

The result is illustrated in FIG. 3B, which shows that the four lanes 4 seen from the left end up with fully filled packages and only the fifth lane 4, the one most to the right, ends up with one non entirely filled package 8, because the last buffer 5, which was not entirely filled (cf. FIG. 3A), is emptied in the package 8. In this way the loss is minimized. Maybe superfluously it is noted that with the end filling mode it could be any of the packing lanes 4 which ends up with the non-entirely filled package 8, not only the one located most downstream as is the case in the example of FIGS. 3A and 3B.

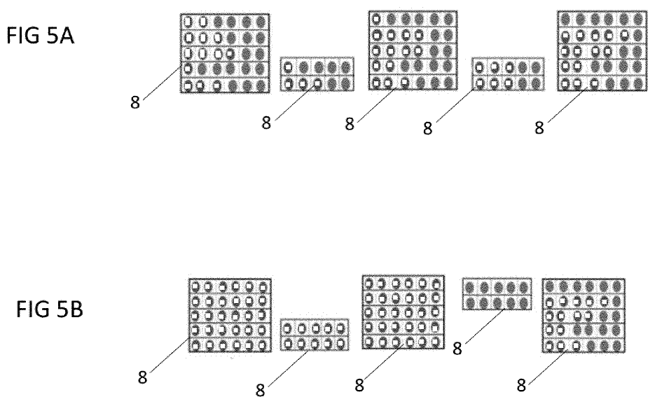

In some applications the eggs of consecutive incoming batches may be mixed. However, the number of packages filled with a mix of two batches is preferably kept to a minimum. The warning system 10 as described in the above can be used in a similar way to minimize the number of packages with a mix of eggs coming from consecutive batches. This is illustrated with reference to FIGS. 5A and 5B.

FIG. 5A shows a situation according to the state of art, in which in all packing lines the packages 8 have a mix of eggs coming from two batches. FIG. 5B shows a situation according to the present invention, in which the mix of eggs from two batches ends up in only one of the packing lanes.

The switch from the normal filling mode to the end filling mode is triggered by the warning signal of the warning system 10 as described in the above. In the end filling mode the respective packing lanes 4 are shut down one by one until there is one packing lane 4 left in operation as is shown in FIG. 3A. Each one of the respective packing lanes 4 is shut down at the moment that the buffer device 5 thereof is fully filled to fill up a row 9 of a package 8 or an entire package 8. The eggs from the next batch are thus only mixed with eggs of the previous batch in the packing lane that is not shut down, thus in FIG. 5B the one to the right. After the last package is filled with mixed eggs, the system can switch to normal filling mode again, whereby all packing lanes are open again. The other packing lanes end up with a package 8 entirely filled with eggs from one batch.

Another egg sorting and packaging system comprises a grading device 2, a circulating conveyor track 3 and a plurality of packing lanes 4 as is shown in FIG. 1 and described in the above.

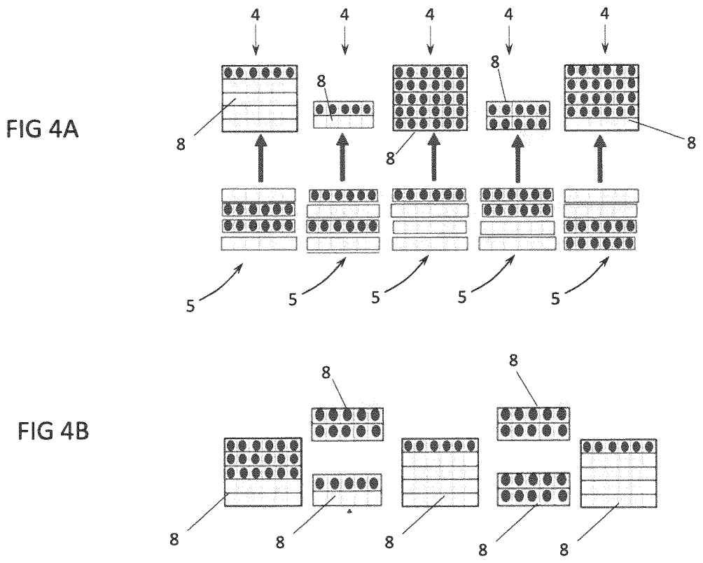

This particular egg sorting and packaging system has an alternative filling mode, in which the eggs 100 are distributed by the circulating conveyor track 3 into the respective buffers 5 using a distribution algorithm which feeds the eggs of a certain product class fed to packing lanes 4 assigned to said product class such that the buffer rows 6 of different packing lanes 4 are filled successively. A buffer row 6 thus can be entirely filled before the eggs 100 on the circulating conveyor track 3 are fed to a next packing lane 4. This is illustrated in FIG. 4A.

When the end of a batch is reached the buffers 5 are emptied in the packages 8, which is illustrated in FIG. 4B.

This particular filling strategy is mainly suitable for filling packages having two rows of products, e.g. for egg cartons having 2×6 pockets. In such a two-row package the chance that the final package in a packing lane is non-entirely filled is 50%. This is already an improvement with regard to the prior art methods, where the chance that each packing line ends up with a non-entirely filled package is considerably higher and may be 100% (cf. FIG. 2B).

In a further embodiment the distribution algorithm feeds the eggs 100 to the buffer 5 of a packing lane 4 such that a package 8 can be entirely filled before eggs 100 are fed to a next packing lane 4. This is less optimal if one looks at the capacity of the entire packing process. However, it is a simple solution which does not require looking forward and a warning system 10 and which eventually also results in only one package 8 which is not entirely filled.

Also, this embodiment is suitable to handle eggs coming from two consecutive batches. With this embodiment at most one package ends up with a mix of products coming from two batches.

The invention may include the following embodiments:

Embodiment I: A product sorting and packaging system comprising:
a grading device for grading the products of a batch into respective product classes,
at least one circulating conveyor track having product holders for receiving the graded products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
wherein the sorting and packaging system has a normal filling mode, in which the products are distributed by the circulating conveyor track into the respective buffers using a distribution algorithm, based on the product classes and an optimal use of the capacity of packing lanes assigned to a certain product class,
wherein the sorting and packaging system has a warning system adapted to detect an end of a batch of products or an end of an order of products and adapted to generate a warning signal when the end of the batch of products is detected or when the end of an order is detected,
wherein the sorting and packaging system has an end filling mode, wherein a switch from the normal filling mode to the end filling mode is triggered by the warning signal of the warning system, and
wherein in the end filling mode the respective packing lanes are shut down one by one until there is one packing lane left in operation, wherein each one of the respective packing lanes is shut down at the moment that the buffer device thereof is fully filled to fill up a row of a package or an entire package.

Embodiment II: The product sorting and packaging system according to Embodiment I, wherein the warning system is adapted to generate the warning signal when the end of the batch or the order is detected at a predetermined location in the supply line, preferably in the grading device.

Embodiment III: The product sorting and packaging system according to Embodiment I, wherein the warning system is adapted to generate the warning signal when is detected that the end of the batch is a predetermined number of products away, e.g. 100, from the first packing lane assigned to the product class concerned.

Embodiment IV: The product sorting and packaging system according to Embodiment III, wherein the warning system takes account of the number of packing lanes and the percentage of products in a product class in the batch.

Embodiment V: A product sorting and packaging system comprising:
a grading device for grading the products of a batch into respective product classes,
at least one circulating conveyor track having product holders for receiving the sorted products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
wherein the sorting and packaging system has a filling mode, in which the products are distributed by the circulating conveyor track into the respective buffers using a distribution algorithm which feeds the products of a certain product class fed to packing lanes assigned to said product class such that the buffer rows of different packing lanes are filled successively, such that a buffer row can be entirely filled before products are fed to a next packing lane.

Embodiment VI: The product sorting and packaging system according to Embodiment V, wherein the distribution algorithm feeds the products to the packing lanes such that a package can be entirely filled before products are fed to a next packing lane.

Embodiment VII: The product sorting and packaging system according to any of the Embodiments I-VI, wherein the system is adapted to sort and package eggs.

Embodiment VIII: A product sorting and packaging method wherein:
products of a batch are sorted into respective product classes,
the sorted products are moved by a circulating conveyor track,
the products are distributed by the circulating conveyor track into respective buffers of a packing lane using a distribution algorithm, based on the product classes and an optimal use of the capacity of packing lanes assigned to a certain product class,
packages are conveyed along the buffer, wherein a filled row of the buffer is transferred to a row in one of the packages,
wherein:
the end of the batch of products is detected or the end of an order of products is detected,
a normal filling mode is switched to an end filling mode based on said end of batch or end of order detection, in which end filling mode the respective packing lanes are shut down one by one until there is one packing lane left in operation, wherein the packing lane is shut down at the moment that the buffer thereof is fully filled and fills up a (final) row of a package or an entire package.

Embodiment IX: The method according to Embodiment VIII, wherein said end of batch or end of order is detected at a predetermined location in the supply line, preferably at a location where the products are sorted.

Embodiment X: The method according to Embodiment IX, wherein, when is detected that the end of the batch is a predetermined number of products away, e.g. 100, from the first packing lane assigned to the product class concerned, the filling mode is switched from the normal filling mode to the end filling mode.

Embodiment XI: The method according to Embodiment X, wherein, when switching the filling mode, account is taken of the number of packing lanes and the percentage of products in a product class in the batch.

Embodiment XII: A product sorting and packaging method comprising:
sorting the products of a batch into respective product classes,
the sorted products are moved by a circulating conveyor track,
the products are distributed by the circulating conveyor track into respective buffers of a packing lane based on the product classes and an optimal use of the capacity of packing lanes assigned to a certain product class,
wherein the products are distributed by the circulating conveyor track into the respective buffers such that the buffer rows of different packing lanes are filled successively, such that a buffer row can be entirely filled before products of the same product class are fed to a next packing lane.

Embodiment XIII: The method according to any of the Embodiments VIII-XII, wherein the products that are sorted and packaged are eggs.

1. A product sorting and packaging system comprising:
a grading device for grading the products of a batch into respective product classes,
at least one circulating conveyor track having product holders for receiving the graded products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
a computer for controlling the sorting and packaging system and configured with a distribution algorithm,
wherein the sorting and packaging system has a normal filling mode, in which the sorting and packaging system is controlled by the computer such that the products are distributed by the circulating conveyor track into the respective buffers using the distribution algorithm, based on the product classes and an optimal use of the capacity of packing lanes assigned to a certain product class,
wherein the sorting and packaging system has a warning system adapted to detect an end of a batch of products or an end of an order of products and adapted to generate a warning signal when the end of the batch of products is detected or when the end of an order is detected,
wherein the sorting and packaging system has an end filling mode, wherein a switch from the normal filling mode to the end filling mode is triggered by the warning signal of the warning system, and
wherein in the end filling mode the sorting and packaging system is controlled by the computer such that the respective packing lanes are shut down one by one until there is one packing lane left in operation, wherein each one of the respective packing lanes is shut down at the moment that the buffer device thereof is fully filled to fill up a row of a package or an entire package.

2. The product sorting and packaging system according to claim 1, wherein the warning system is adapted to generate the warning signal when the end of the batch or the order is detected at a predetermined location in the supply line, preferably in the grading device.

3. The product sorting and packaging system according to claim 2, wherein the warning system comprises a computer and a detector, wherein the computer is configured to run an algorithm, which generates a warning signal based on the input signal coming from the detector.

4. The product sorting and packaging system according to claim 1, wherein the warning system is adapted to generate the warning signal when is detected that the end of the batch is a predetermined number of products away, from the first packing lane assigned to the product class concerned.

5. The product sorting and packaging system according to claim 4, wherein the warning system is incorporated in said computer for controlling the sorting and packaging system.

6. The product sorting and packaging system according to claim wherein the warning system takes account of the number of packing lanes and the percentage of products in a product class in the batch.

7. A product sorting and packaging system comprising:
a grading device for grading the products of a batch into respective product classes,
at least one circulating conveyor track having product holders for receiving the sorted products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package,
a computer for controlling the sorting and packaging system and configured with a distribution algorithm,
wherein the sorting and packaging system has a filling mode, in which the products are distributed by the circulating conveyor track into the respective buffers using the distribution algorithm which feeds the products of a certain product class fed to packing lanes assigned to said product class such that the buffer rows of different packing lanes are filled successively, such that a buffer row can be entirely filled before products are fed to a next packing lane.

8. The product sorting and packaging system according to claim 7, wherein the distribution algorithm feeds the products to the packing lanes such that a package can be entirely filled before products are fed to a next packing lane.

9. The product sorting and packaging system according to any of the claim 1, wherein the system is adapted to sort and package eggs.

10. The product sorting and packaging system according to claim 1 or 7, wherein the computer is configured to know where individual products are in the sorting and packaging system.

11. A product sorting and packaging method wherein:
products of a batch are sorted into respective product classes,
the sorted products are moved by a circulating conveyor track,
in a normal filling mode, the products are distributed by the circulating conveyor track into respective buffers of a packing lane using a distribution algorithm, based on the product classes and an optimal use of the capacity of packing lanes assigned to a certain product class,
packages are conveyed along the buffer, wherein a filled row of the buffer is transferred to a row in one of the packages,
the end of the batch of products is detected or the end of an order of products is detected,
the normal filling mode is switched to an end filling mode based on said end of batch or end of order detection, in which end filling mode the respective packing lanes assigned to a certain product class are shut down one by one until there is one packing lane assigned to said product class left in operation, wherein the packing lane is shut down at the moment that the buffer thereof is fully filled and fills up a (final) row of a package or an entire package.

12. The method according to claim 11, wherein said end of batch or end of order is detected at a predetermined location in the supply line.

13. The method according to claim 12, wherein, when is detected that the end of the batch is a predetermined number of products away, from the first packing lane assigned to the product class concerned, the filling mode is switched from the normal filling mode to the end filling mode.

14. The method according to claim 13, wherein, when switching the filling mode, account is taken of the number of packing lanes and the percentage of products in a product class in the batch.

15. A product sorting and packaging method comprising:
sorting the products of a batch into respective product classes,
the sorted products are moved by a circulating conveyor track,
the products are distributed by the circulating conveyor track into respective buffers of a packing lane based on the product classes and an optimal use of the capacity of packing lanes assigned to a certain product class,
wherein the products are distributed by the circulating conveyor track into the respective buffers such that the buffer rows of different packing lanes are filled successively, such that a buffer row can be entirely filled before products of the same product class are fed to a next packing lane.

16. The method according to 11 or 15, wherein the products that are sorted and packaged are eggs.

17. A product sorting and packaging system comprising:
a grading device for grading the products of a batch into respective product classes,
at least one circulating conveyor track having product holders for receiving the graded products from the grading device,
a plurality of packing lanes associated with the circulating conveyor track, wherein each packing lane includes a buffer device having a plurality of rows of product holders for receiving individual products from the product holders of the circulating conveyor track, and wherein each packing lane includes a package conveyor to convey packages along the buffer device, wherein the packing lane is adapted to transfer a filled row of the buffer device to a row in a package, wherein the sorting and packaging system has a normal filling mode, in which the products are distributed by the circulating conveyor track into the respective buffers using a distribution algorithm, based on the product classes and an optimal use of the capacity of packing lanes assigned to a certain product class,
wherein the sorting and packaging system has a warning system adapted to detect an end of a batch of products or an end of an order of products and adapted to generate a warning signal when the end of the batch of products is detected or when the end of an order is detected,
wherein the sorting and packaging system has an end filling mode, wherein a switch from the normal filling mode to the end filling mode is triggered by the warning signal of the warning system,
wherein in the end filling mode the respective packing lanes are shut down one by one until there is one packing lane left in operation, wherein each one of the respective packing lanes is shut down at the moment that the buffer device thereof is fully filled to fill up a row of a package or an entire package, and
wherein the product sorting and packaging system further comprises a computer configured to carry out the method according to 11 or 15.
